(19) United States
(12) Patent Application Publication
(10) Pub. No.: US 2016/0004989 A1
(43) Pub. Date: Jan. 7, 2016

(54) METHODS FOR PRIORITIZING AND ASSIGNING ONE OR MORE EXCEPTIONS AND DEVICES THEREOF

(71) Applicant: WIPRO LIMITED, Bangalore (IN)

(72) Inventors: Sudeep Somanna Reddy, Bangalore (IN); Shilpa Goel, Bangalore (IN)

(21) Appl. No.: 14/464,382

(22) Filed: Aug. 20, 2014

(30) Foreign Application Priority Data
Jul. 7, 2014 (IN) 3340/CHE/2014

(51) Int. Cl. G06Q 10/06

(52) U.S. Cl. CPC G06Q 10/063112; G06Q 10/067

(57) ABSTRACT

A method, non-transitory computer readable medium and exception management computing device for obtaining one or more exceptions and information associated with each of the obtained one or more exceptions. Each of the obtained one or more exceptions is classified as either a relevant exception or a non-relevant exception based on the obtained information associated with each of the obtained one or more exceptions. Each of the obtained one or more exceptions classified as being the relevant exception is prioritized based on one or more business rules. The prioritized one or more relevant exceptions are assigned to the one or more agents based on one or more skills of the one or more agents prioritized.

This application claims the benefit of Indian Patent Application Filing Number 3340/CHE/2014, filed on Jul. 7, 2014, which is hereby incorporated by reference in its entirety.

### FIELD

This technology relates to methods for prioritizing and assigning one or more exceptions and devices thereof.

### BACKGROUND

Every day people work on exceptions by identifying and following predefined standard operating procedures to provide solutions to various problems. These exceptions are originating from processes executing over various computer systems on different platforms and often at different locations. Due to computer intelligence and digitization, more and more of these exceptions are being created on a real time/daily basis.

Currently, these exceptions are solved by people, usually referred as agents, who are trained to solve the exceptions. To solve these exceptions, agents need certain data as set forth in standard procedures defined to solve these exceptions. As the number of these exceptions continues to increase, it is becoming more and more difficult for agents to know all the standard operating procedures for all the possible types of exceptions. Additionally, with increasing numbers of exceptions, it is becoming more and more difficult for agents to solve these exceptions quickly and efficiently. Further, these agents are under pressure to not only handle and solve this growing number of exceptions, but to do so while improving their performance on resolving these exceptions.

Existing solutions are not able to address these problems stemming from the growing numbers of exceptions. For example, existing solutions require agents to manually analyze and prioritize exceptions. This manual process is inefficient and results in large numbers of inconsistencies in processing exceptions.

### SUMMARY

A method for prioritizing and assigning one or more exceptions includes an exception management computing device for obtaining one or more exceptions and information associated with each of the obtained one or more exceptions. Each of the obtained one or more exceptions is classified by the exception management computing device as either a relevant exception or a non-relevant exception based on the obtained information associated with each of the obtained one or more exceptions. The obtained one or more exceptions classified as being the relevant exception is checked for solvability based on one or more business rules and potentially solvable exceptions are prioritized by the exception management computing device based on one or more business rules. The prioritized one or more relevant potentially solvable exceptions are assigned by the exception management computing device to the one or more agents based on one or more skills of the one or more agents prioritized.

A exception management computing device comprising a memory coupled to one or more processors which are configured to execute programmed instructions stored in the memory includes obtaining one or more exceptions and information associated with each of the obtained one or more exceptions. Each of the obtained one or more exceptions is classified as either a relevant exception or a non-relevant exception based on the obtained information associated with each of the obtained one or more exceptions. The obtained one or more exceptions classified as being the relevant exception is checked for solvability based on one or more business rules and potentially solvable exceptions are prioritized based on one or more business rules. The prioritized one or more relevant potentially solvable exceptions are assigned to the one or more agents based on one or more skills of the one or more agents prioritized.

A non-transitory computer readable medium having stored thereon instructions for prioritizing and assigning one or more exceptions comprising machine executable code which when executed by at least one processor, causes the processor to perform steps including obtaining one or more exceptions and information associated with each of the obtained one or more exceptions. Each of the obtained one or more exceptions is classified as either a relevant exception or a non-relevant exception based on the obtained information associated with each of the obtained one or more exceptions. The obtained one or more exceptions classified as being the relevant exception is checked for solvability based on one or more business rules and potentially solvable exceptions are prioritized based on one or more business rules. The prioritized one or more relevant potentially solvable exceptions are assigned to the one or more agents based on one or more skills of the one or more agents prioritized.

This technology provides a number of advantages including providing more effective methods, devices, and non-transitory computer readable medium for prioritizing and assigning one or more exceptions to agents. This technology uses business rules to categorize relevant and non-relevant exceptions and only the relevant exceptions are checked for solvability and only potentially solvable exceptions are automatically prioritized. With this technology, only relevant exceptions are automatically prioritized which saves agents time and effort. Additionally, this technology substantially improves the average handling time to process an exception. Further, this technology makes this process of managing exceptions much more consistent and error free.

### BRIEF DESCRIPTION OF THE DRAWINGS

FIG. 1 is an example of a network environment with a exception management computing device for prioritizing and assigning one or more exceptions;

FIG. 2 is an example of a block diagram of the exception management computing device shown in FIG. 1;

FIG. 3 is an example of a functional block diagram of the modules within the memory of the exception management computing device shown in FIG. 1;

FIG. 4 is an example of a flowchart for a method for prioritizing and assigning one or more exceptions;

FIGS. 5-6 are examples of tables illustrating classification of exceptions based on business rules; and

FIG. 7 is an example of a table illustrating assigning priority to exceptions.

### DETAILED DESCRIPTION

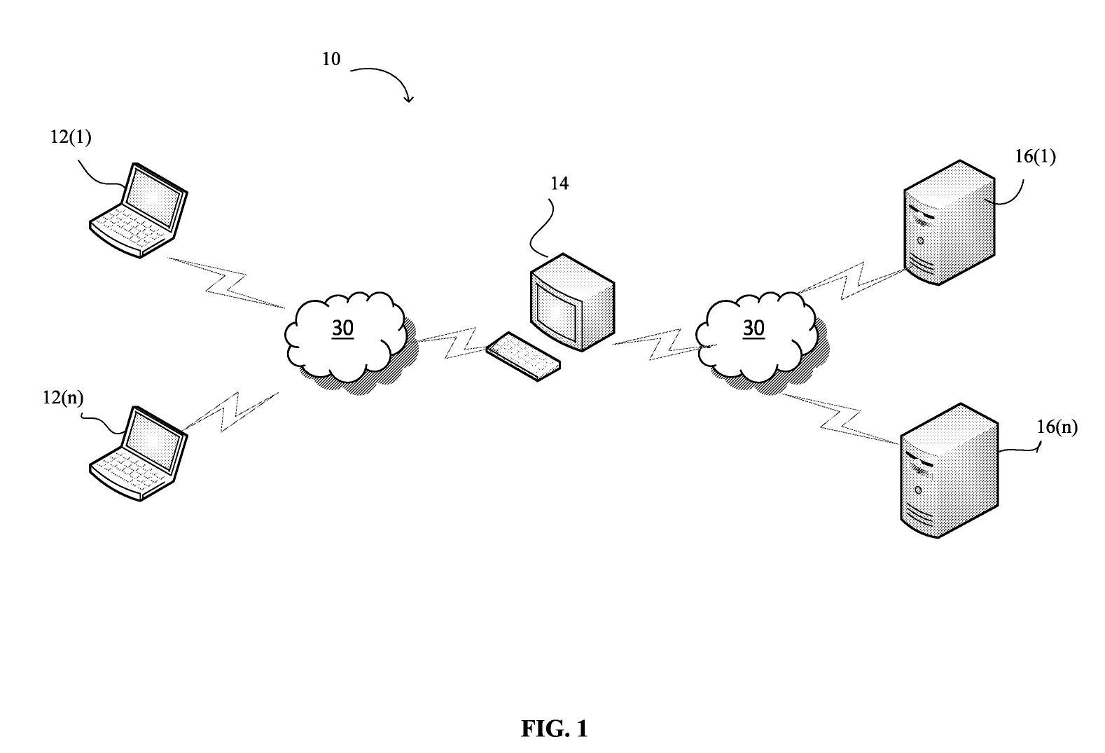

An exemplary network environment 10 with an exception management computing device 14 for prioritizing and assigning one or more exceptions is as illustrated in FIG. 1. The exemplary network environment 10 includes a plurality of agent processing computing devices 12(1)-12(n), the exception management computing device 14, and plurality of servers 16(1)-16(n) which are coupled together by the communication networks 30, although the environment can include other types and numbers of systems, devices, components, elements and/or communication networks in a variety of other topologies and deployments. While not shown, the exemplary environment 10 may include additional components, such as routers, switches and other devices which are well known to those of ordinary skill in the art and thus will not be described here. This technology provides a number of advantages including providing more effective methods, non-transitory computer readable medium and devices for prioritizing and assigning one or more exceptions.

Referring more specifically to FIG. 1, exception management computing device 14 interacts with the plurality of agent processing computing devices 12(1)-12(n) and plurality of servers 16(1)-16(n) through the communication networks 30, although the exception management computing device 14 can interact with the agent processing computing devices 12(1)-12(n) and the plurality of servers 16(1)-16(n) using other methods or techniques. Communication networks 30 include local area networks (LAN), wide area network (WAN), 3G technologies, GPRS or EDGE technologies, although the communication networks 30 can include other types and numbers of networks and other network topologies.

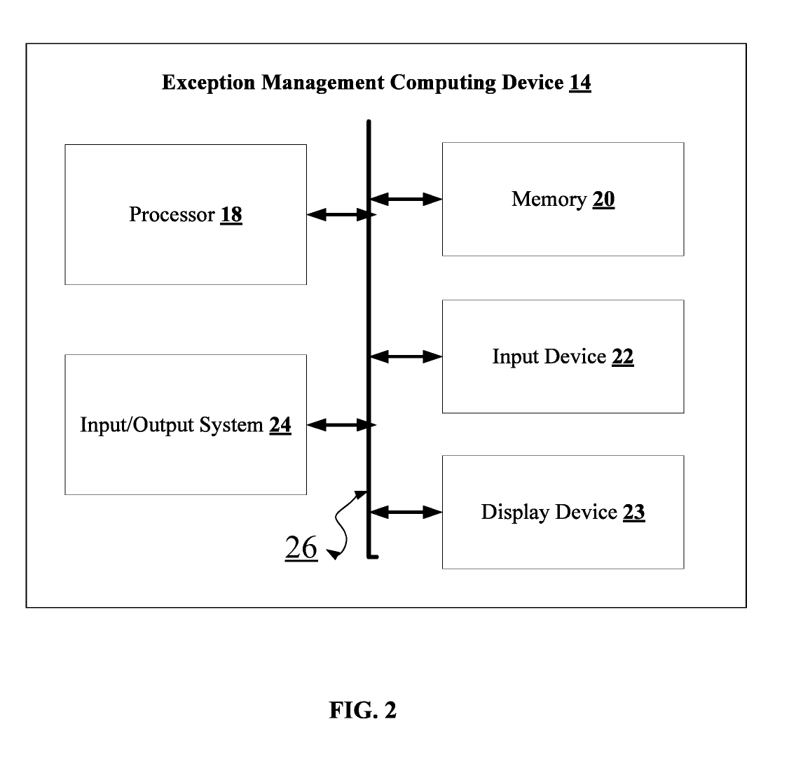

The exception management computing device 14 within a network environment 10 as illustrated and described with the examples herein, although exception management computing device 14 may perform other types and numbers of functions and in other types of networks. As illustrated in FIG. 2, the exception management computing device 14 includes at least one processor 18, memory 20, input device 22 and display device 23, and input/output (I/O) system 24 which are coupled together by bus 26, although exception management computing device 14 may comprise other types and/or numbers of elements in other configurations.

Processor(s) 18 may execute one or more computer-executable instructions stored in the memory 20 for the methods illustrated and described with reference to the examples herein, although the processor(s) can execute other types and numbers of instructions and perform other types and numbers of operations. The processor(s) 18 may comprise one or more central processing units (“CPUs”) or general purpose processors with one or more processing cores, such as AMD® processor(s), although other types of processor(s) could be used (e.g., Intel®).

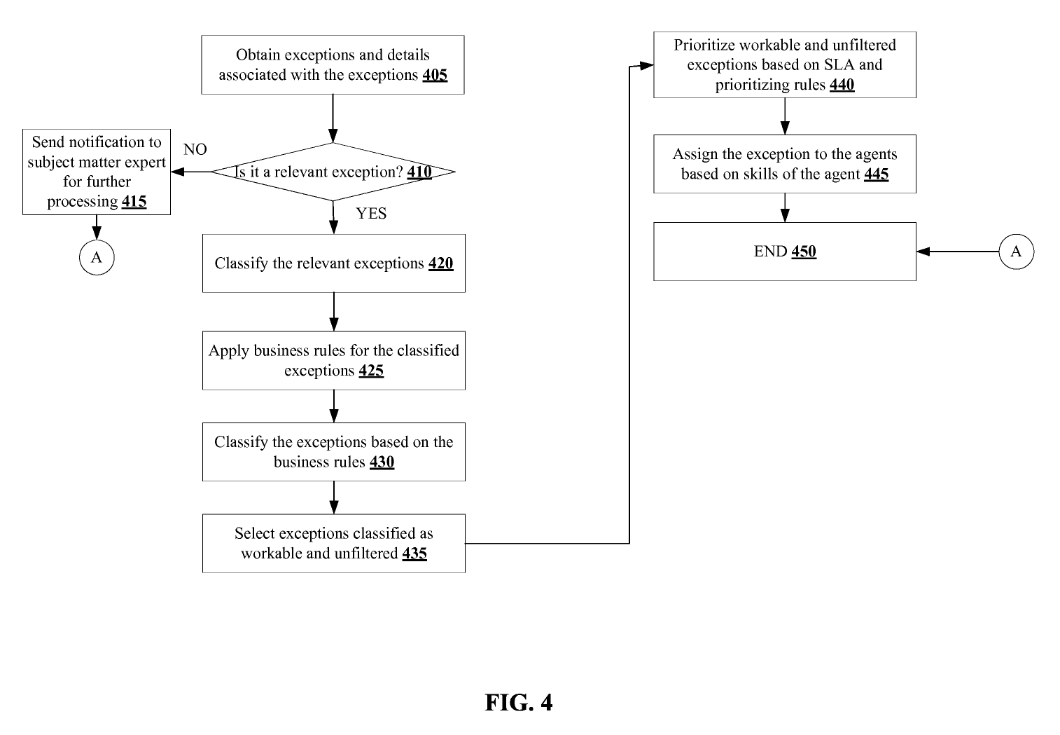

Memory 20 may comprise one or more tangible storage media, such as RAM, ROM, flash memory, CD-ROM, floppy disk, hard disk drive(s), solid state memory, DVD, or any other memory storage types or devices, including combinations thereof, which are known to those of ordinary skill in the art. Memory 20 may store one or more programmed instructions of this technology as illustrated and described with reference to the examples herein that may be executed by the one or more processor(s) 18. By way of example only, the flow chart shown in FIG. 4 are representative of programmed steps or actions of this technology that may be embodied or expressed as one or more non-transitory computer or machine readable having stored instructions stored in memory 20 that may be executed by the processor(s) 18, although other types and numbers of programmed instructions and/or other data may be stored.

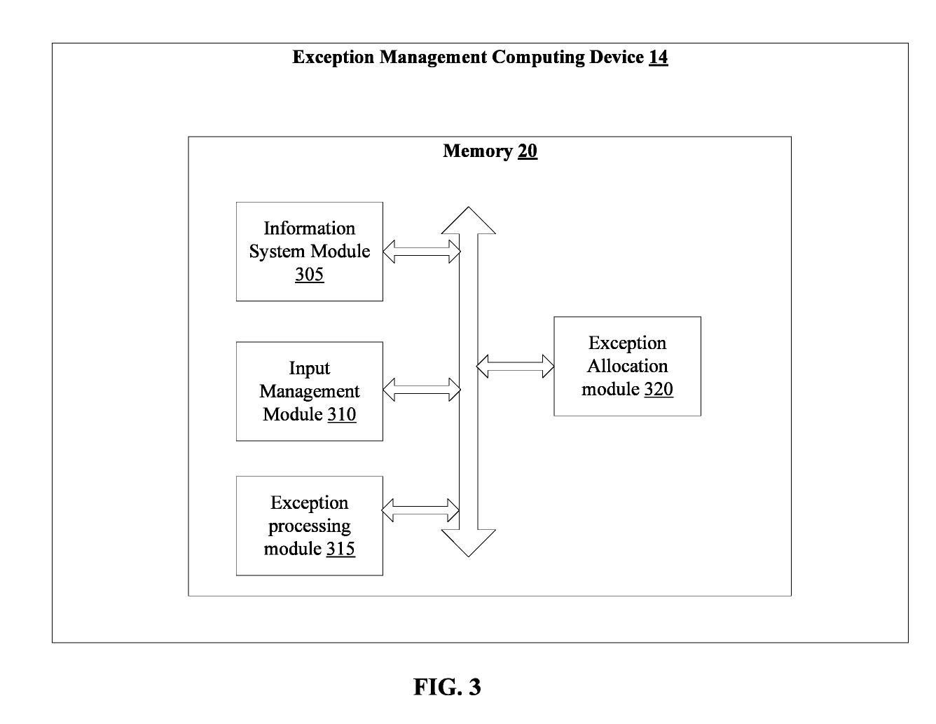

Additionally as illustrated in FIG. 3, memory 20 includes an information system module 305, input management module 310, exception processing module 315 and an exception allocation module 320 to assist the exception management computing device 14 for prioritizing and assigning one or more exceptions, although the memory 20 could include other types and/or numbers of modules.

The information system module 305 includes all the exception related data and the additional data from different systems required to process the exception, although the information system module 305 can include other types or amounts of information. The exception data consists of all the new exceptions, pending exceptions which are not yet completed and the completed exceptions list on a daily basis. Along with the exception data, there are different information systems which provide additional set of information related to the exception. Based on the exception data, the exception will be further processed and allocated to agents in the most optimal way after each exception is processed in the exception processing module 315.

The input management module 310 is the interface between exception processing module 315 and the exception related data and the different information systems which provide the data related to the exception, although the input management module 310 can perform other types or amounts of functions. Whenever additional data is required for processing of the exception, the input management module 310 facilitates the communication and acts as interface.

Next the exception processing module 315 further includes sub modules such as rules engine, categorization engine, splitting engine and optimization engine, although the exception processing module can include other types or amounts modules. The rules engine and framework generates unmatched or non relevant job list and eligible or relevant job list based on eligibility rules which are part of simple business rules, although the rules engine and framework can include other types or amounts of information. The rules within the rules engine can be configured based on the capability of the agents to process the exception, although the rules within the rules engine can be configured based on other conditions. The categorization engine within the exception processing module 315 assists with categorizing exceptions into categorizes such as workable, pending, non-workable, unfiltered, although the exceptions can be classified as other types of categorizes. In this example, the workable exception relates to set of exceptions which can be completely processed. The pending exceptions relates to the set of exceptions which cannot be processed due to some process dependency. The non workable exception relate to the set of exceptions which cannot be processed by the agents and unfiltered exceptions relates to the set of jobs which have not been subjected to any of the configured rules. The splitting engine and optimization engine groups the exceptions based on skills of the agents who can work on the exceptions, although the splitting engine can perform other types and/or numbers of operations.

The exception allocation module 320 assists with optimally allocating the exceptions to the agents, although the exception module 320 can perform other types and amounts of functions. In this example, the exception allocation module 320 will ensure that the exceptions which are solvable and are of high priority or exceptions having critical service-level agreement are first assigned to agents to process. The exceptions which are of less important are assigned to agents once the high priority jobs are completed.

Input device 22 enables a user, such as an administrator, to interact with the exception management computing device 14, such as to input and/or view data and/or to configure, program and/or operate it by way of example only. By way of example only, input device 22 may include one or more of a touch screen, keyboard and/or a computer mouse.

The display device 23 enables a user, such as an administrator, to interact with the exception management computing device 14, such as to view and/or input information and/or to configure, program and/or operate it by way of example only. By way of example only, the display device 23 may include one or more of a CRT, LED monitor, LCD monitor, or touch screen display technology although other types and numbers of display devices could be used.

The I/O system 24 in the exception management computing device 14 is used to operatively couple and communicate between the exception management computing device 14, the agent processing computing devices 12(1)-12(n) and plurality of servers 16(1)-16(n) and which are all coupled together by communication network 30. In this example, the bus 26 is a hyper-transport bus in this example, although other bus types and links may be used, such as PCI.

Each of the plurality of agent processing computing devices 12(1)-12(n) includes a central processing unit (CPU) or processor, a memory, an interface device, and an I/O system, which are coupled together by a bus or other link, although other numbers and types of network devices could be used. The plurality of agent processing computing devices 12(1)-12(n) communicate with the exception management computing device 14 for receiving exceptions, although the agent processing computing devices 12(1)-12(n) can interact with the exception management computing device 14 by other techniques. The plurality of agent processing computing devices 12(1)-12(n) may run interface application(s), such as a Web browser, that may provide an interface to make requests for and receive content and/or communicate with web applications stored on the plurality of servers 16(1)-16(n) via the communication network 30.

The network environment 10 also includes the plurality of servers 16(1)-16(n). Each of the plurality of servers 16(1)-16(n) includes a central processing unit (CPU) or processor, a memory, an interface device, and an I/O system, which are coupled together by a bus or other link, although other numbers and types of network devices could be used. The plurality of servers 16(1)-16(n) communicate with the exception management computing device 14 through communication network 30, although the servers 16(1)-16(n) can interact with the exception management computing device 14 by other techniques. Various network processing applications, such as CIFS applications, NFS applications, HTTP Web Server applications, and/or FTP applications, may be operating on the plurality of servers 16(1)-16(n) and transmitting content (e.g., files, Web pages) to the plurality of agent processing computing devices 12(1)-12(n) or the exception management computing device 14 in response to the requests.

Although an exemplary telecommunications network environment 10 with the plurality of agent processing computing devices 12(1)-12(n), exception management computing device 14 and plurality of servers 16(1)-16(n) are described and illustrated herein, other types and numbers of systems, devices in other topologies can be used. It is to be understood that the systems of the examples described herein are for exemplary purposes, as many variations of the specific hardware and software used to implement the examples are possible, as will be appreciated by those skilled in the relevant art(s).

Furthermore, each of the systems of the examples may be conveniently implemented using one or more general purpose computer systems, microprocessors, digital signal processors, and micro-controllers, programmed according to the teachings of the examples, as described and illustrated herein, and as will be appreciated by those of ordinary skill in the art.

The examples may also be embodied as a non-transitory computer readable medium having instructions stored thereon for one or more aspects of the present technology as described and illustrated by way of the examples herein, as described herein, which when executed by a processor, cause the processor to carry out the steps necessary to implement the methods of the examples, as described and illustrated herein.

An exemplary method for prioritizing and assigning one or more exceptions will now be described with reference to FIGS. 1-7. Particularly with reference to FIG. 4, in step 405 the exception management computing device 14 obtains information associated with exceptions from the plurality of servers 16(1)-16(n), although the exception management computing device 14 can obtain the information from other locations and sources. For purpose of further illustration, the term exception in this example relates to a pending job that is required to be performed by an agent using one of the agent processing computing devices 12(1)-12(n) in this example, although the term exception can relate to other types of pending processes. In this example, the obtained information relates to a list of all the new, pending and closed exception detail data along with first level information associated with the exceptions. By way of example only, if the obtained exceptions are relating to a water bill, then the first level information would be relating to, date of creating of the water bill exception, type of the water bill exception, issue category of the water bill exception, the time period mentioned in the service level agreement (SLA) for the water bill exception, any pending or previous invoices for a particular meter reading, the due date for the next meter reading, date on which the meter was last replaced, although the first level information can include other types or amounts of information associated with the obtained exceptions.

In step 410, the exception management computing device 14 determines whether any of the obtained exceptions are relevant exceptions that are required to be processed by one of the agents using one of the agent processing computing devices 12(1)-12(n). In this example, the exception management computing device 14 determines whether each of the obtained exceptions are relevant exceptions based on obtained first level information associated with each of the exceptions, although the exception management computing device 14 can determine using other parameters. By way of example only, if the water bill exception relates to a missing water meter reading and if the first level information indicates that the water meter is stolen, then the exception management computing device 14 would determine the water bill exception to be a non-relevant exception because the agent using one of the agent processing computing devices 12(1)-12(n) may not be process the water bill exception. However, if the water bill exception relates to a missing invoice for a particular water meter and the first level information indicates that the invoice was accidently not generated for the water meter, then the exception management computing device 14 determines that the water bill exception is a relevant exception. The exception is determined to be relevant in this example because the agent using one of the agent processing computing devices 12(1)-12(n) can easily generate an invoice. Accordingly, if the exception management computing device 14 determines that the obtained exception is a non-relevant exception, then the No branch is taken to step 415 where the exception management computing device 14 creates a list and provides a notification to the subject matter expert to further process the exception and the exemplary method ends. By way of example only, if the exception management computing device 14 determines that the water bill exception is a non-relevant exception because of a stolen water meter, then the exception management computing device 14 sends a notification to the field agent to add a new water meter.

However, if in step 410 the exception management computing device 14 determines that the obtained expectation is a relevant exception, then the Yes branch is taken to step 420. In step 420, the expectation management computing device 14 classifies each of the relevant exceptions as a new exception, a pending exception, or a closed exception based on the comparing the obtained relevant exception with pending relevant exceptions within the exception management computing device 14, although other types and/or numbers of classifications could be used. In this example, the exceptions which are appearing for the first time are considered as new exceptions; the exceptions which exist within the exception management computing device 14 and are still in open state in the exception management computing device 14 are considered as pending exceptions; and the exceptions which were previously cancelled or closed either by the exception management computing device 14 or one of the plurality of agent processing computing devices 12(1)-12(n) are considered as closed jobs.

In step 425, the exception management computing device 14 applies one or more business rules to the classified exceptions. In this example, the exception management computing device 14 has stored or can otherwise retrieve a pre-defined list of business rules which are required to be applied to each of the classified exceptions. The business rules relate to conditions which are required to be satisfied by the exceptions for next level of processing. By way of example only, the business rules can be checking for the availability of accurate data in the obtained first level information, such as, date of creation of the water bill exception, type of the water bill exception, issue category of the water bill exception, the time period mentioned in the service level agreement (SLA) for the water bill exception, any pending or previous invoices for a particular meter reading, the due date for the next meter reading and date on which the meter was last replaced. Therefore, checking for availability of accurate data for each of the obtained first level information can be considered as one business rule, although business rules can relate to other types and/or numbers of other conditions and aspects. In this example, the accuracy of the data relates to the information being in a proper format. For example, the date of creation of the water bill is required to be in a date, month and year format.

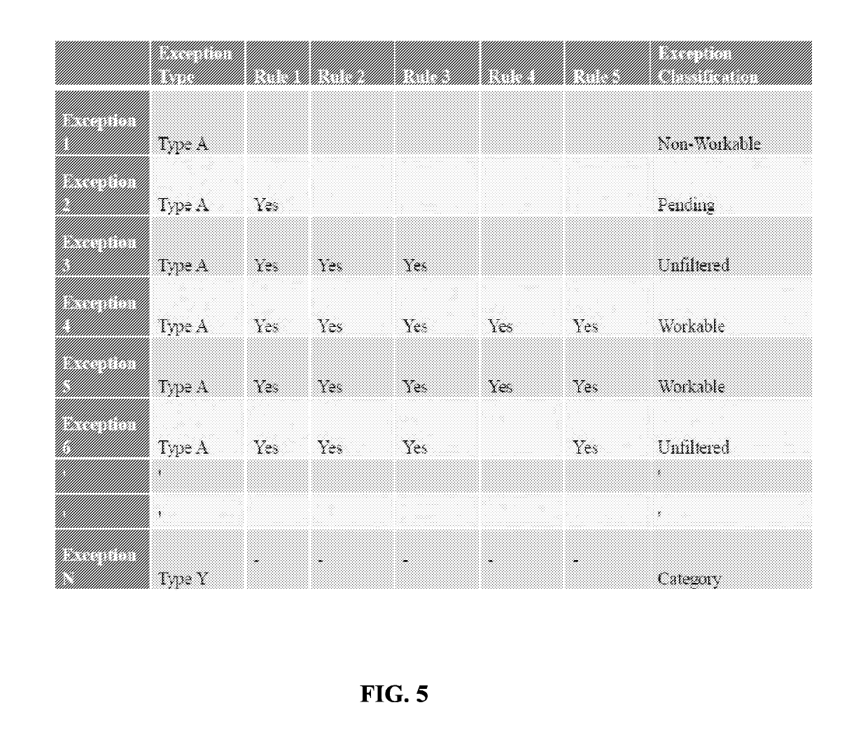

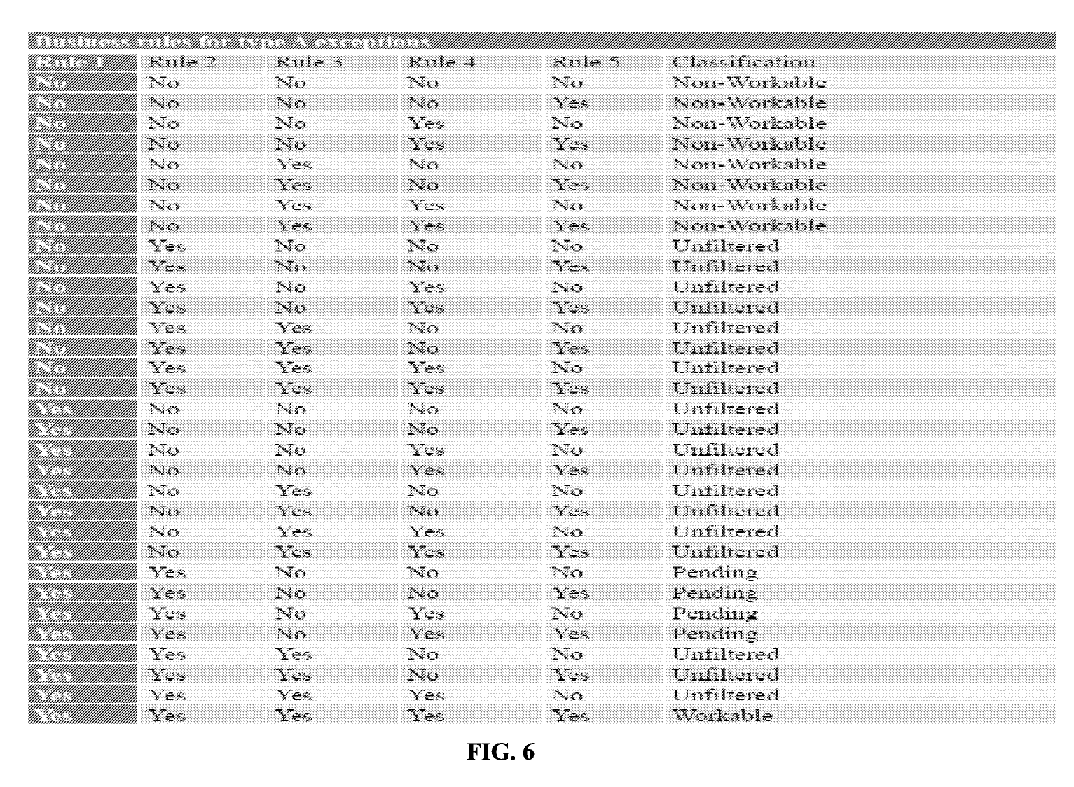

In step 430, the exception management computing device 14 classifies the relevant exceptions based on the business rules associated with the type of the exception. In this example, the exception management computing device 14 classifies the relevant exceptions as workable exceptions, pending exceptions, non-workable exceptions or unfiltered exceptions, although the exception management computing device 14 can classify the exceptions into other types and/or numbers of categories. The business rules in this example are dynamic and can be easily customized based on the type of exceptions and the availability of the data in the first level information. For purpose of further illustration with reference to FIG. 5, the exception management computing device 14 classifies exception 5 as a workable exception when all the business rules are satisfied, i.e., when all the data is accurately available for the obtained first level information. In this example, the exception management computing device 14 classifies the exception 3 as an unfiltered exception when the first level information associated with the exception may not be subjected to the business rule 4 and business rule 5. By way of example only, if the exception 3 is relating to a missing water bill and business rule 4 and business rule 5 relate to checking if there is accurate data for availability of electricity, then business rules 4 and 5 are not subjected to the exception 3. Next, the exception management computing device 14 classifies exception 2 as pending exception when the exception cannot be processed due to non-availability of dependent or related data thereby not satisfying the business rules 2-5. Finally, the exception management computing device 14 classifies exception 1 as non-workable exception when all the business rules are not satisfied, i.e., when all data in the obtained first level information is either inaccurate or not available. Additionally, FIG. 6 also illustrates the different business rules that are required to be satisfied by the exception of type A to be classified as workable, unfiltered, pending or non-workable by the exception management computing device 14. Alternatively in another example, the exception management computing device 14 can fetch the required data when the data is determined to be missing in the obtained first level information to conform to the business rules.

In step 435, the exception management computing device 14 selects only exceptions that were classified as workable and unfiltered in step 430. Additionally, the exception management computing device removes all the exceptions that were classified as non-workable and pending to create a separate list for processing at a later time. By way of example only, the exception management computing device 14 selects exceptions 3, 4 and 5 illustrated in FIG. 5.

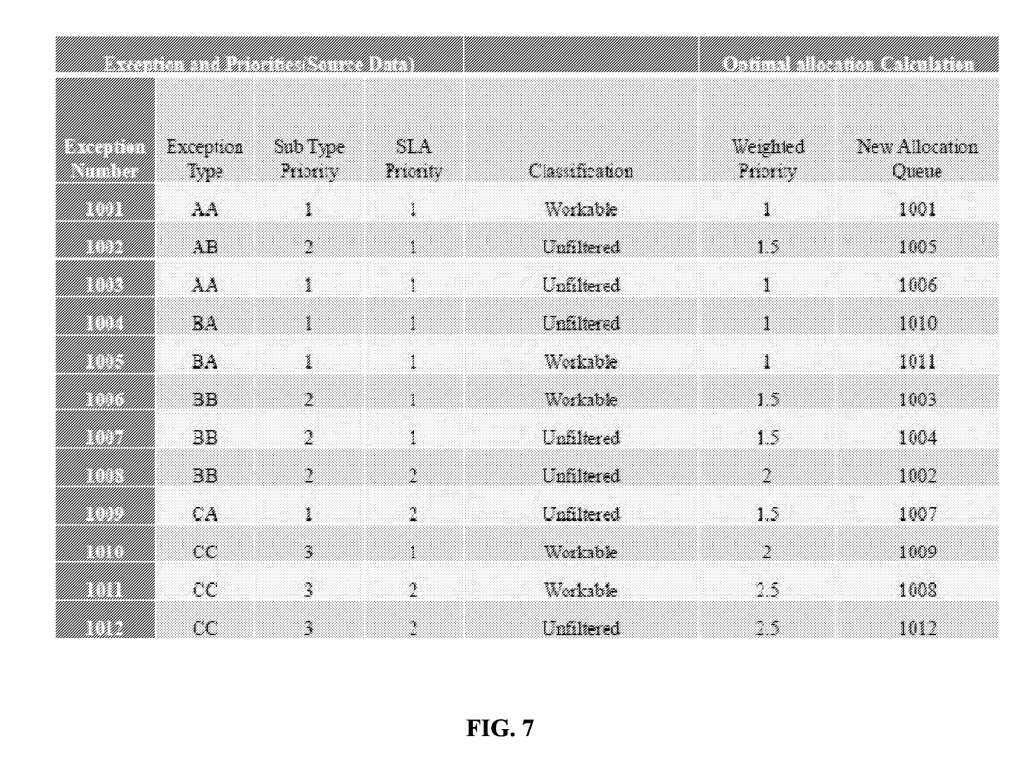

In step 440, the exception management computing device 14 prioritizes only the selected workable and unfiltered exceptions based on the SLA and prioritizing rules, although the exception management computing device 14 can prioritize the exception using other parameters or techniques. By way of example only, the exception management computing device 14 prioritizes the exception in the order of exception 4, exception 5 and exception 3 as exception 4 has a smaller SLA than exception 5 and exception 3. In this example, the prioritizing rules can relate to different priority rules such as time of the received exception, order of the received exception, although the priority rules can include other types and amounts of rules. Additionally, the exception management computing device 14 can assign a weighted value to the parameters, such as a SLA, and the prioritizing rules and then assign the priority to the exceptions. By way of example only with reference to FIG. 7, the exception management computing device 14 first assigns a sub priority for the exception 1001 based on the type of the exception and the corresponding value stored within memory 20. For example, if the exception 1001 relates to a bill not being generated for six years and if the threshold number for absence of a bill being generated is one year, then the sub priority of exception 1001 will be one because it has a high sub priority. Next, the exception management computing device 14 assigns a SLA priority depending on a table that includes the required time for completion of the exception and the corresponding values. For example, if the requirement time for completion is very close to the current time, then the exception management computing device 14 assigns a higher priority to the exception 1001. Finally, the exception management computing device 14 computes a weighted priority by adding the sub priority type and the SLA priority and dividing it by 2 and the exception is placed within a processing queue. In this example, a priority value 1 indicates a highest priority and priority values such as 1.5, 2, 2.5, indicates decreasing order of the priority in which the exceptions have to be processed.

In step 445, the exception management computing device 14 assigns prioritized exceptions to the agents using the plurality of agent processing computing devices 12(1)-12(n) for further processing. In this example, the exception management computing device 14 assigns the exceptions to the agents based on a stored skill set of each of the agents, although other approaches for assignment based on other types and/or numbers of factors could be used. In another example, the exceptions could be assigned to a group of agents based on overall stored skill sets using the plurality of agent processing computing devices 12(1)-12(n). In step 450, this example of the process ends.

Having thus described the basic concept of the invention, it will be rather apparent to those skilled in the art that the foregoing detailed disclosure is intended to be presented by way of example only, and is not limiting. Various alterations, improvements, and modifications will occur and are intended to those skilled in the art, though not expressly stated herein. These alterations, improvements, and modifications are intended to be suggested hereby, and are within the spirit and scope of the invention. Additionally, the recited order of processing elements or sequences, or the use of numbers, letters, or other designations therefore, is not intended to limit the claimed processes to any order except as may be specified in the claims. Accordingly, the invention is limited only by the following claims and equivalents thereto.

What is claimed is:

1. A method for prioritizing and assigning one or more exceptions, the method comprising:
obtaining, by an exception management computing device, one or more exceptions and information associated with each of the obtained one or more exceptions;
classifying, by the exception management computing device, each of the obtained one or more exceptions as either a relevant exception or a non-relevant exception based on the obtained information associated with each of the obtained one or more exceptions;
prioritizing, by the exception management computing device, each of the obtained one or more exceptions classified as being the relevant exception based on one or more business rules; and
assigning, by the exception management computing device, the prioritized one or more relevant exceptions to one or more agents based on one or more skills of the one or more agents.

2. The method as set forth in claim 1 wherein the prioritizing further comprises classifying, by the exception management computing device, each of the obtained one or more exceptions classified as being the relevant exception as a new exception, an existing exception, or a closed exception based on the obtained information associated with each of the obtained one or more exceptions classified as being the relevant exception.

3. The method as set forth in claim 1 further comprising creating, by the exception management computing device, a list including each of the obtained one or more exceptions classified as being the non-relevant exception.

4. The method as set forth in claim 3 further comprising sending, by the exception management computing device, the created list to a subject matter expert or a field agent for further processing of each of the obtained one or more exceptions classified as being the non-relevant exception.

5. The method as set forth in claim 1 wherein the prioritizing further comprises classifying, by the exception management computing device, each of the obtained one or more exceptions classified as a non-workable exception, pending exception, fully workable exception, or unfiltered exception based on one or more business rules.

6. The method as set forth in claim 5 further comprising assigning, by the exception management computing device, the prioritized one or more relevant exceptions to the one or more agents further based on a service level agreement.

7. A utility management computing device comprising:
a processor;
a memory, wherein the memory coupled to the processor which are configured to execute programmed instructions stored in the memory comprising:
obtaining one or more exceptions and information associated with each of the obtained one or more exceptions;
classifying each of the obtained one or more exceptions as either a relevant exception or a non-relevant exception based on the obtained information associated with each of the obtained one or more exceptions;
prioritizing each of the obtained one or more exceptions classified as being the relevant exception based on one or more business rules; and
assigning the prioritized one or more relevant exceptions to one or more agents based on one or more skills of the one or more agents.

8. The device as set forth in claim 7 wherein the processor is further configured to execute programmed instructions stored in the memory for the prioritizing further comprises classifying each of the obtained one or more exceptions classified as being the relevant exception as a new exception, an existing exception, or a closed exception based on the obtained information associated with each of the obtained one or more exceptions classified as being the relevant exception.

9. The device as set forth in claim 7 wherein the processor is further configured to execute programmed instructions stored in the memory further comprising creating a list including each of the obtained one or more exceptions classified as being the non-relevant exception.

10. The device as set forth in claim 9 wherein the processor is further configured to execute programmed instructions stored in the memory further comprising sending the created list to a subject matter expert or a field agent for further processing of each of the obtained one or more exceptions classified as being the non-relevant exception.

11. The device as set forth in claim 7 wherein the processor is further configured to execute programmed instructions stored in the memory for the prioritizing further comprises classifying each of the obtained one or more exceptions classified as a non-workable exception, pending exception, fully workable exception, or unfiltered exception based on one or more business rules.

12. The device as set forth in claim 11 wherein the processor is further configured to execute programmed instructions stored in the memory further comprising assigning the prioritized one or more relevant exceptions to the one or more agents further based on a service level agreement.

13. A non-transitory computer readable medium having stored thereon instructions for prioritizing and assigning one or more exceptions comprising machine executable code which when executed by at least one processor, causes the processor to perform steps comprising:
obtaining one or more exceptions and information associated with each of the obtained one or more exceptions;
classifying each of the obtained one or more exceptions as either a relevant exception or a non-relevant exception based on the obtained information associated with each of the obtained one or more exceptions;
prioritizing each of the obtained one or more exceptions classified as being the relevant exception based on one or more business rules; and
assigning the prioritized one or more relevant exceptions to one or more agents based on one or more skills of the one or more agents.

14. The medium as set forth in claim 13 wherein the prioritizing further comprises classifying each of the obtained one or more exceptions classified as being the relevant exception as a new exception, an existing exception, or a closed exception based on the obtained information associated with each of the obtained one or more exceptions classified as being the relevant exception.

15. The medium as set forth in claim 13 further comprising creating a list including each of the obtained one or more exceptions classified as being the non-relevant exception.

16. The medium as set forth in claim 15 further comprising sending the created list to a subject matter expert or a field agent for further processing of each of the obtained one or more exceptions classified as being the non-relevant exception.

17. The medium as set forth in claim 13 prioritizing further comprises classifying each of the obtained one or more exceptions classified as a non-workable exception, pending exception, fully workable exception, or unfiltered exception based on one or more business rules.

18. The medium as set forth in claim 17 further comprising assigning the prioritized one or more relevant exceptions to the one or more agents further based on a service level agreement.
